(19) United States
(12) Patent Application Publication
(10) Pub. No.: US 2003/0133436 A1
(43) Pub. Date: Jul. 17, 2003

(54) TELEPHONE NETWORK MANAGEMENT METHOD AND DEVICES

(76) Inventors: MONICA PATEL, BRAMPTON (CA); EDWARD HALL, OTTAWA (CA); GEOFFREY HANSON, OTTAWA (CA); SUBHASH BANERJEE, CARY, NC (US); BRYAN CORLETT, MISSISSAUGA (CA); MARIO DEFACENDIS, THORNHILL (CA); SHARON YUE, NORTH YORK (CA); SHAO-XI XING, TORONTO (CA)

Correspondence Address: WITHROW & TERRANOVA, P.L.L.C., P.O. BOX 1287, CARY, NC, 27512, US

(21) Appl. No.: 09/221,110

(22) Filed: Dec. 28, 1998

(51) Int. Cl. H04L 12/66

(52) U.S. Cl. 370/352

(57) ABSTRACT

A method and devices for managing telephony switches, and thus telephone networks is disclosed. The method and devices allow communication with a telephony switch by way of a packet switched computer network such as the internet. Operations and management messages adhering to a known, pre-defined format, are encapsulated in data packets exchanged over the network.

### FIELD OF THE INVENTION:

The present invention relates to telephony networks and more particular to a method and devices permitting operations and administration management of telephony switches and thus telephone networks.

### BACKGROUND OF THE INVENTION:

A desire to manage the operation and administration of telephony networks and switches has long been recognized. Such management may include collection and exchange of data relating to telephony trunks; traffic measurement and management; configuration of telephony switches; fault analysis; performance measurement and management; and overall network management. In modern digital switches, such management may be effected remotely, by using computing devices hosting network traffic management or data collection software. Such remote computers may typically contact a switch by way of a dedicated circuit, formed by way of modem connection or the like.

In fact, commonly adopted standards are documented in BELLCORE SPCS/OS—NNDC OS Interface, FCD 45-09-0100 Interface Requirements, TR-TSY-000740, Issue Jun. 2, 1997 (the “TR-TSY-000740 Document”) and SPCS/OS—NTM OS Interface via NNDC OS, FSD 45-18-0403 Interface Requirements, TR-NWT-000746, Issue Jun. 3, 1997 (the “TR-NWT-000746 Document”) the contents of both which are hereby incorporated by reference.

These standards, however, are predicated on the use of a protocol requiring a dedicated circuit and utilize the BELLCORE X.25 protocol.

In recent years, the existence of computer networks, such as local and wide area networks and the public internet have become common place. Accordingly, interconnecting telephony switches with such networks, and managing those switches using computer networks would be desirable. In fact, some existing switches adhere to the simple network management protocol (“SNMP”). As understood by those skilled in the art, the SNMP is a connectionless internet protocol allowing the management of network interconnected devices. However, the SNMP cannot rely on the methodologies of existing network management protocols, while taking advantage of the existence of computer networks.

Accordingly, an improved method for managing the operation and administration of telephony switches by way of a computer network is desirable.

### SUMMARY OF THE INVENTION

According to the present invention, messages for managing the operation and administration of telephony switches are exchanged between a computing device and a switch using a packet switched data network interconnecting the switch and computing device. Data is requested by exchanging at least one packet including: (i.) a network address identifying the telephony switch on the packet switched network; (ii.) a network address identifying the computing device; (iii.) a first message type identifier, identifying the packet as containing a data request message; and (iv.) a second message type identifier, identifying a type of operations and management data requested from the telephony switch, The first message type identifier, allows messages to be exchanged by way of the present invention. The second message type identifier, allows messages encapsulated in the packet to be compliant with at least one existing telephony switch/network operations and management protocol.

In response to a request for operations and management data, a packet including (i.) a network address identifying said telephony switch on the packet switched network; (ii.) a network address identifying the computing device; (iii.) a first message type identifier, identifying the packet as containing a message formed in response to a request; (iv.) a second message type identifier, identifying a type of operations and management data provided by the telephony switch in the packet is formed and forwarded to the a computing device using the data network. Again, the second message type identifier, within the packet allows messages encapsulated in the packet to be compliant with at least one existing telephony switch/network operations and management protocol.

In accordance with another aspect of the invention, operations and management data between a telephony switch and a computing device, are exchanged by establishing at least a first and second network connections between the computing device and the telephony switch over a packet switched data network; exchanging data having a first priority over the first network connection; and concurrently exchanging data having a second priority over the second network connection.

Again, multiple connection facilitate exchange of messages compliant with at least one existing telephony switch/network operations and management protocol.

Other aspects and features of the present invention will become apparent to those of ordinary skill in the art upon review of the following description of specific embodiments of the invention in conjunction with the accompanying figures.

### BRIEF DESCRIPTION OF THE DRAWINGS:

In figures, which illustrate by way of example only, embodiments of the present invention,

FIG. 1 illustrates a telephony switch in communication with computing devices, exemplary of preferred embodiments of the present invention;

FIG. 2 illustrates an exemplary architecture of a computing device of FIG. 1;

FIG. 3 illustrates an exemplary organization of memory of the computing of FIG. 2;

FIG. 4 illustrates the format of message headers of messages transferred from a telephony switch and interconnected computing devices;

FIG. 5 illustrates the general format of messages transferred between a switch to computing devices of FIG. 1 in a manner exemplary of the present invention;

FIGS. 6A-6G illustrates the format of portions of specific types of messages of the type illustrated in FIG. 5, exchanged between the DMS and computing devices of FIG. 1;

FIG. 7 is a flow diagram illustrating the exchange of messages between the switch and computing devices of FIG. 1; and

FIGS. 8 and 9 are flow charts illustrating steps in methods exemplary of the present invention.

### DETAILED DESCRIPTION:

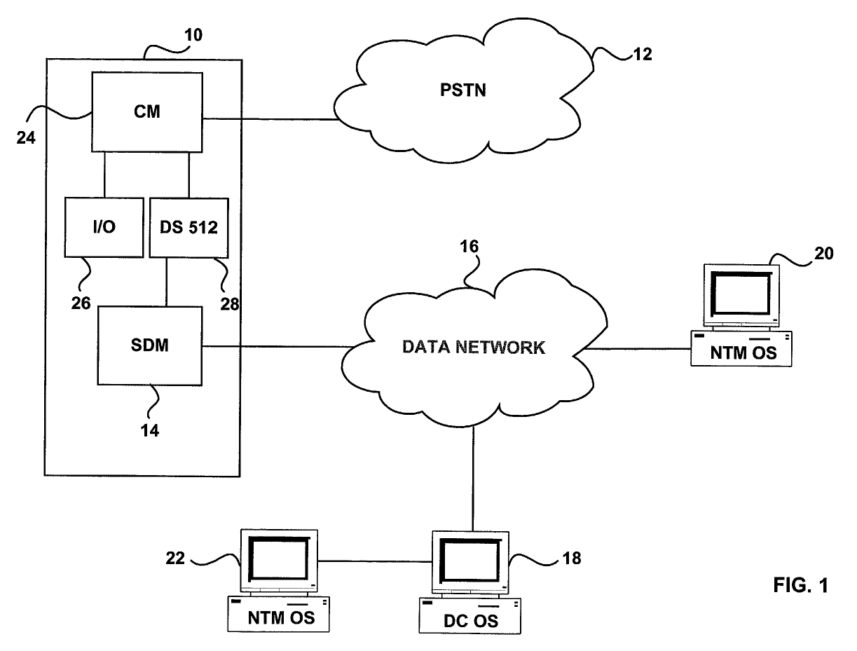

FIG. 1 illustrates a digital telephony switch 10 interconnected by way of packet switched data network 16 with computing devices 18, and 20 exemplary of embodiments of the present invention. Computing device 22 is further interconnected, by way of a dedicated link, with computing device 18.

Switch 10 is preferably a typical digital multiplex switch (“DMS”), available from NORTEL NETWORKS, such as NORTEL model DMS-100/200; DMS-250; DMS-300; DMS-500 as known to those skilled in the art. As such, switch 10 comprises a central computing module (“CM”) 24 in communication with a general purpose input/output port 26 and at least one DS512 telephony data interface 28. Of course, switch 10 is preferably interconnected with a telephony network 12, which is preferably the public switched telephone network (“PSTN”). Switch 10 further preferably comprises a Super Node Data Manager (“SDM”) operation administration platform 14.

SDM platform 14 is an additional computing device forming part of switch 10 used primarily for collection of data and administration of the remainder of switch 10. Preferably, SDM platform 14 is a UNIX based computing device, including suitable application software, in communication with CM 24 of switch 10 by way of DS512 interface 28, using any suitable interface and protocol. Further forming part of SDM platform 14 is a suitable data network interface, such as an ethernet interface, an asynchronous transfer mode or ISDN interface, or any other suitable interface interconnecting SDM platform 14 to data network 16. Network 16 is preferably a packet switched computer network, such as a local or wide area computing network adhering to the internet protocols (“IP”), SPX protocols, or the like. Most preferably network 16 is the public internet, or a network interconnected with the public internet. As such, SDM platform 14 further comprises a conventional internet protocol stack, allowing communication with network 16 using the uniform datagram protocol (“UDP/IP”); the transport control protocol (“TCP/IP”); and other conventional IP protocols as detailed in RFC 791 and RFC 768, the contents of both of which are hereby incorporated by reference.

Switch 10, (preferably SDM platform 14) includes interface software, exemplary of the present invention, to communicate with computers equipped with a network data collection operating system (“NDC OS”) software, and preferably Network Traffic Management Operating System (”NTM OS”) software. As will be appreciated by those skilled in the art, the NDC OS and NTM OS software allow traffic, measurement and management of switch 10, by delivering and obtaining NDC OS messages (formerly known as Engineering and Administrative Data Acquisition System (“EADAS”) messages), as detailed in the TR-NWT-000746 Document and TR-NWT-00740 Document. Known NDC OS and NTM OS packages are available from LUCENT, BELLCORE and SCANDIA in association with trademarks TDMS, DCOS 2000, and NTDCA.

In the example embodiment, device 18 hosts modified NDC OS software, exemplary of the present invention, while device 20 host modified NTM OS software, exemplary of an embodiment of the present invention. Device 22 hosts conventional, unmodified NTM OS software.

Each of devices 18, 20 and 22 is preferably a conventional network client computing device such as a UNIX based workstations available from SUN MICROSYSTEMS, or HEWLETT PACKARD. Devices 18, 20 or 22, may of course be any other suitable computing device. In the illustrated embodiments, computing devices 18, 20, and 22 are substantially similar.

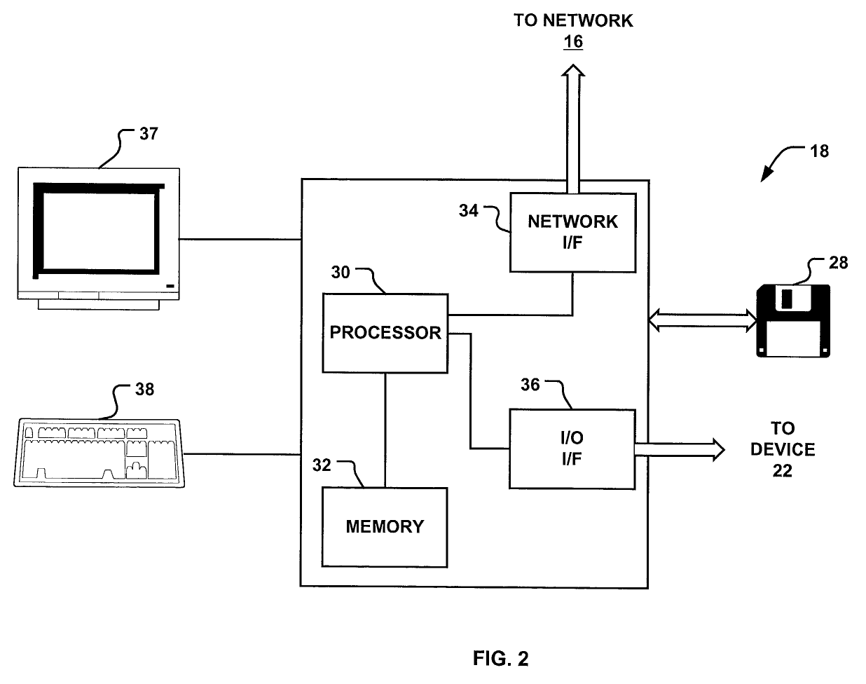

An exemplary architecture of device 18 is illustrated in FIG. 2. Device 18 acts as a data network based client, that may be permanently or intermittently connected to data network 16. As illustrated, device 18 comprises a processor 30, in communication with persistent storage memory 32, and a network interface 34. Persistent storage memory 32 preferably comprises a combination of read only memory, random access memory, disk storage, and the like. Additionally, persistent storage memory 32 further preferably comprises a device capable of reading data from a removable storage medium 28, such as a diskette, CD-ROM or the like for storage in other portions of memory 32. Network interface 34 may be an ethernet interface, a modem, an asynchronous transfer mode or ISDN interface, or any other suitable interface for connecting device 18 to network 16. A monitor 37 and input device 38, such as a keyboard, further preferably form part of device 12 allowing input and display of end-user data. Additionally, a further input/output interface 36, such as a conventional serial port, forms part of device 18 for interconnection with computing device 22 (FIG. 1).

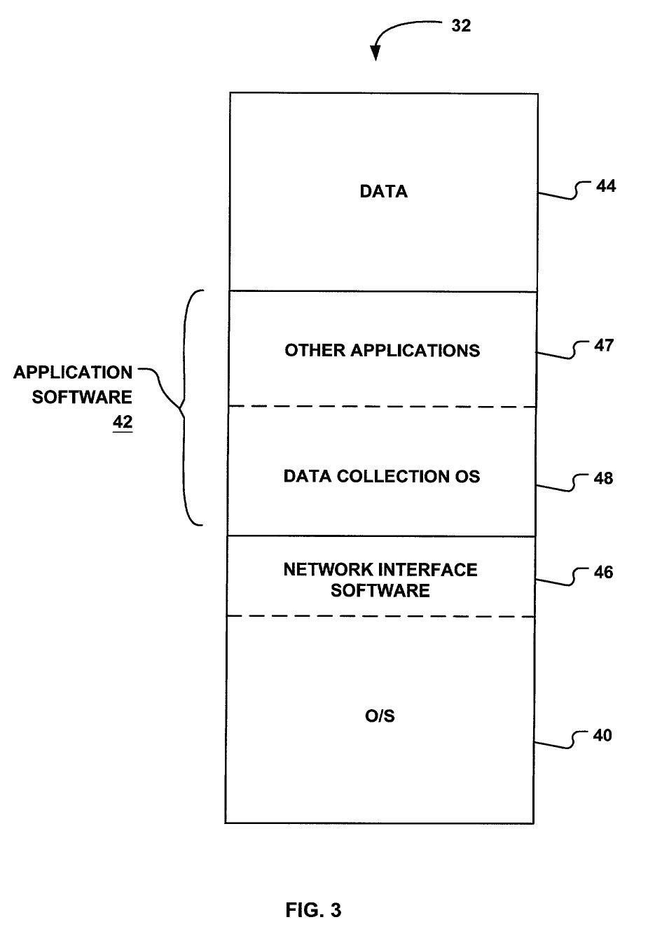

An exemplary organization of persistent storage memory 32 of device 18 is illustrated in FIG. 3. Stored within memory 32 are computer software programs and data that are loaded into working memory of device 18 to permit device 18 to be operable as a computer network based client computing device. As illustrated, memory 32 stores core operating system software 40; application software 42; and data 44. Operating system software 40 may, for example, SUN solaris, HP-UX UNIX operating system software, or the like. Application software 42 comprises modified NDC OS software 48, exemplary of the present invention. Network interface software 46 preferably including an internet protocol suite, preferably forms part of operating system software 40, but could form part of application software 42. Network interface software 46 allows connection with network 16 and communication of device 18 and thus operating system 40 and application software 42, with network 16, through the physical network interface 34.

Typically, computing devices hosting conventional NDC OS or NTM OS software are in communication with telephony switches using protocols defining the physical, link, packet, and application layers as defined in TR-NWT-000740 Document. As previously noted, computing devices hosting NDC OS software have typically communicated with a switch, like switch 10 using input/output port 26, that may include a serial port and one or more modems, interconnected with dedicated links or telephone dial-in lines. Devices hosting NTM OS software typically communicate with a switch by way a device hosting NDC OS software, to which they are connected by way of another dedicated link. As specified in the TR-TSY-000740 Document, NDC OS and NTM OS software conventionally utilize the Bell X.25 (or BX.25) protocol, defining physical, packet and link layers (as these layers are understood in the Open Standards Interconnect (“OSI”) model) of a communications protocol, to communicate with a switch, such as switch 10. As a dedicated link is used to interconnect computing devices hosting conventional NDC OS software and a switch, transport, session and presentation layers of the communications protocol are not implemented. The application layer directly interfaces with the packet layer.

As described in the TR-TSY-000740 Document, the application layer of the communications protocol allows computing devices hosting conventional NDC OS software to communicate with a switch using protocol well suited for polling. Specifically, a computer hosting conventional NDC OS software preferably automatically polls a switch at intervals of 5 and 30 minutes; as well as hourly and daily to collect traffic related data. Additionally, a device hosting NDC OS software may originate control, scheduling and audit messages.

In order to allow the concurrent transmission of messages the application layer, as defined in the TR-NWT-000740 document, uses three logical BX.25 channels to exchange messages between computing devices hosting conventional NDC OS and NTM OS software and a switch. This allows the relatively long transmission of relatively low-priority data, such as data associated with a 30-minute poll, to occur in the presence of the exchange of high-priority messages, such as messages relating to time of day data or the like.

Specifically a first logic channel (Channel 1) is used to exchange time of day; suspect data; not equipped; discretes; control; NDC OS planned downtime; and invalid request response (for logical channel 1) messages.

A second logical channel (Channel 2) is used to exchange 5-minute data; time conflict data; not equipped; and invalid response (for logical channel 2) messages.

A third logical channel (Channel 3) is used to exchange data relating to 30 minute data; hourly data; daily data; time conflicts (for polls on channel 3); audit messages; schedule messages; not equipped; and invalid response (for logical channel 3) messages. The message assignments for logical channels are further detailed in the TR-TSY-000740 Document.

The precise format of each application level message (hereafter referred to as an “NDC OS Message”) is detailed in the TR-NWT-000746 Document and TR-TSY-00740 Document. The format of NDC OS Messages depends on the type of message and whether the message originates with computing devices hosting the NDC OS, or with switch 10.

As noted, in the illustrated preferred embodiment, computing devices 18 and 20 host modified NDC OS and NTM OS software packages, exemplary of the present invention that are in communication with SDM platform 14 by way of a data network 16, and not by way of a conventional dedicated link.

Advantageously, however, the application layer NDC OS Message format as described in TR-TSY-000740 Document and the TR-NWT-000746 Document is preserved. As will become, apparent, computing devices 18, 20 and 22 and thus the hosted modified NDC OS or NTM OS sofware may communicate with switch 10 using network 16 and known data networking protocols. Advantageously, software at switch 10 allows for exchange for NDC OS compliant messages by way of network 10 and in conventional ways, by way of interface 26.

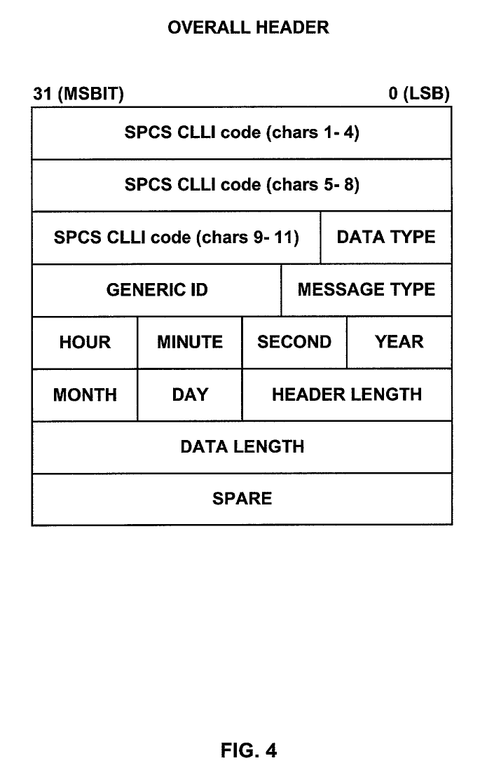

Notably, each NDC OS Message passed from switch 10 to modified NDC OS software 48 at devices 18, comprises a generic header illustrated in FIG. 4, and includes an eleven byte ASCII switch identifier (known as a CLLI Code) as well as a one octet data type, identifying the data type of the message; a generic identifier used to identify the software used to exchange the messages; a message type; a time stamp; a header length; a data length field; and a spare. Each generic message header may be followed by a section specific header as defined in the TR-NWT-000740 Document. The generic and section headers are followed by a data section as also detailed in the TR-TSY-00740 and TR-NWT-000746 document.

NDC OS Messages originating with device 18 hosting modified NDC OS software 48, comprise a request type field, and a one byte parameter, as detailed in the TR-NWT-000740 Document and the TR-TSY-000746 Document.

Accordingly, exemplary of the present invention, a known network transport layer, such as TCP/IP, and a session layer, as detailed below, are used to communicate between switch 10 and computing devices 18 and 20 hosting modified NTM OS and NDC OS software, while maintaining the format of conventional application layer (NDC OS) messages.

NDC OS software 48 (FIG. 3) preferably comprises a standard NDC OS application such as those currently available from BELLCORE, LUCENT or SCANDIA adapted to run on the hardware platform of computing device 18, but modified to communicate with network interface software 46, and to perform steps exemplary of the present invention. Modified NDC OS software 48 may be formed by modifying conventional NDC OS software using standard programming techniques known to those skilled in the art. Alternatively, modified NDC OS software 48 embodying the present invention could be developed without modification to existing software, using programming techniques known to those skilled in the art.

Specifically, modified NDC OS software 48 is adapted to communicate with switch 10 using the application level protocol defined in the TR-TSY-000740, and TR-TSY-00746 documents. As will become apparent, in the preferred embodiment, messages conforming to this application level protocol are encapsulated in TCP/IP packets and transmitted over network 16 to SDM platform 14.

As such modified NDC OS software 48, has been modified to use internet protocol stack of network interface software 46 of OS 40, in place of the data link layer protocols defined in the TR-TSY-000740 Document. Specifically, modified NDC OS software 48 uses multiple TCP/IP connections, as detailed in RFC 768 as the data link between NDC OS software 48 and SDM platform 14. Accordingly, data link and transport layers are defined by the TCP/IP and IP protocols, detailed in RFCS 768 and 791. Similarly, data network 16 is used as the physical layer. A preferred session layer protocol used by modified NDC OS sofware 48 is described below.

The architecture of device 20 has not been specifically illustrated. However, device 20 is substantially identical to device 18, but hosts a modified NTM OS, modified in a manner exemplary of the present invention in place of NDC OS software 48. Conveniently modified NTM OS software at device 20 may communicate with switch 10 by way of network 16, and without any reliance on device 18. In fact, device 20 may communicate concurrently with device 18 over network 16 using network connections established directly between device 20 and switch 10.

Device 22 is also a conventional computing device, hosting an unmodified NTM OS, as for example the NETMINDER software. Device 22 comprises a physical interface, such as a conventional modem, serial port or the like adapting device 22 to interconnect directly with device 18, as illustrated.

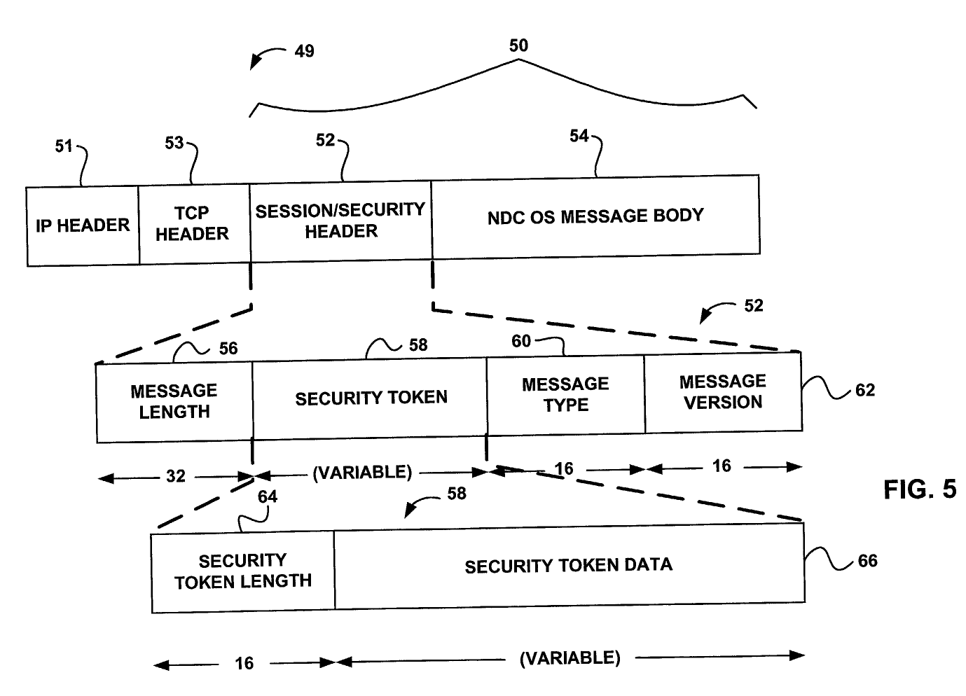

The general format of messages exchanged between device 18 or the modified NTM OS software of device 20 and switch 10 over network 16 is illustrated in FIG. 5. In the described embodiment, each message takes the form of a packet compliant with the TCP/IP protocols. A person skilled in the art will appreciate that, depending on the length of the message, multiple TCP/IP packets may be formed and exchanged in order to exchange a single message. As illustrated, each example packet 49 comprises data network specific headers 51 and 53, which in the preferred embodiment comprise IP and TCP/IP headers, respectively, as detailed in RFC 791 and 768. Accordingly, headers 51 and 53 at least comprise IP addresses identifying the message originator and recipient.

Each message further comprises a message portion 50 formed by modified NDC OS software 48 or complementary software at SDM OS 14, comprising a session/security header 52 and an NDC OS Message body 54 (ie. a message portion compliant with conventional NDC OS messages). As further illustrated, session/security header 52 comprises a thirty-two bit message length field 56; a variable length security token field 58; a sixteen bit message type field 60 and a further sixteen bit message version field 62. Further, security token field 58 comprises a security token length field 64 and a security token data field 66.

Message length field 56 indicates the length in bytes of message portion 50, excluding field 56. Similarly, security token length field 64 indicates the length of security token data field 66 in bytes. Security token field 58 is preferably generated in its entirety by the Generic Security Service Application Program Interface (“GSS-API”) as detailed in RFCs 1508, 1509 and 2078, the contents of each of which is hereby incorporated by reference.

Message type field 60 may currently have one of the following six values, representing the following message types:

TABLES I and II
Message Types

| NTM/NDC OS Originating Messages | |
|---|---|
| Message Type | Message Description |
| 1 | LOGIN_REQUEST |
| 3 | LOGOUT_REQUEST |
| 5 | EADAS_REQUEST |
| SDM Originating Messages | |
| Message Type | Message Description |
| 2 | LOGIN_REPLY |
| 4 | LOGOUT_REPLY |
| 6 | EADAS_REPLY |

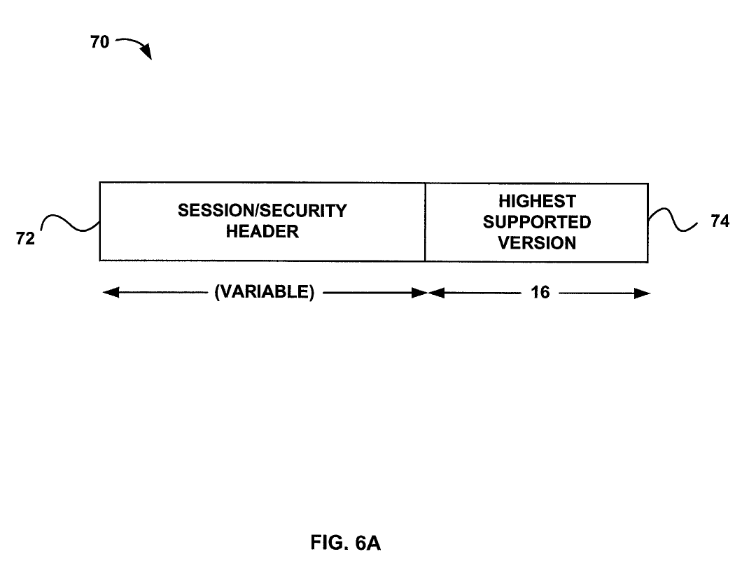

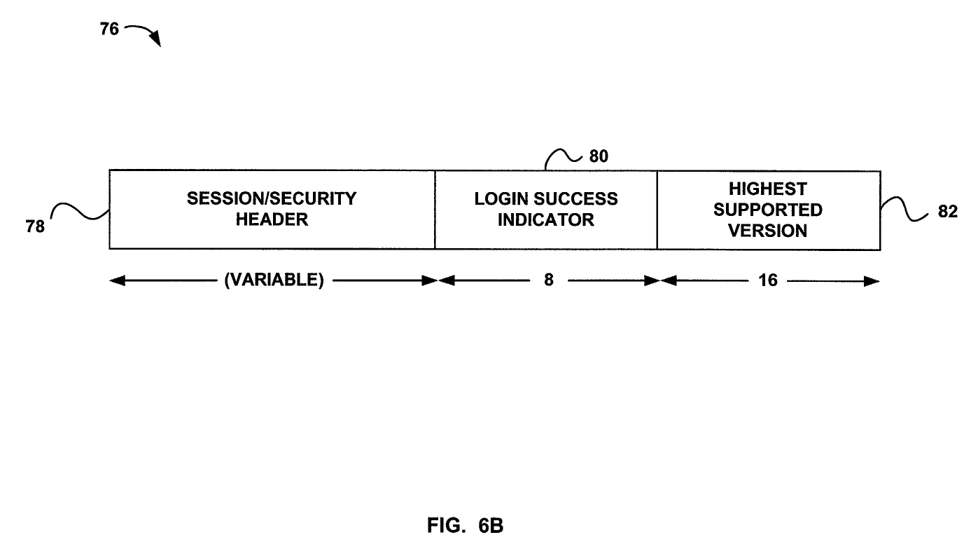

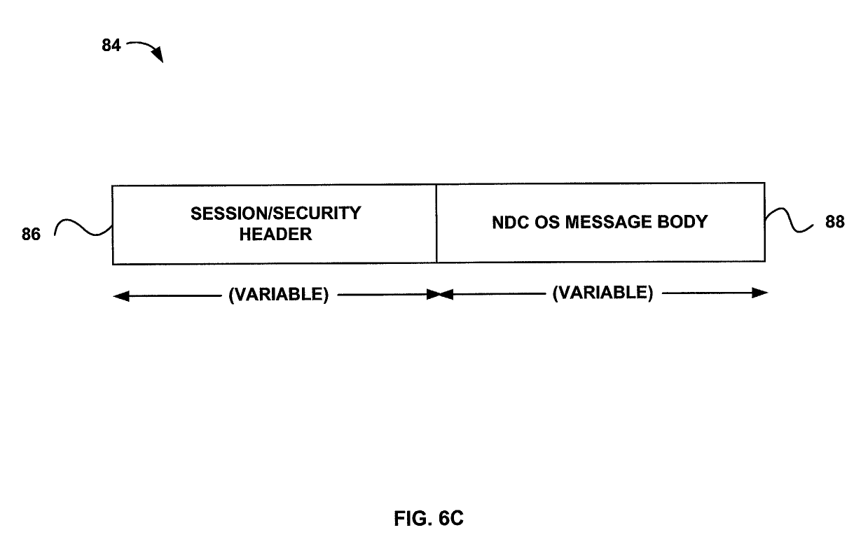

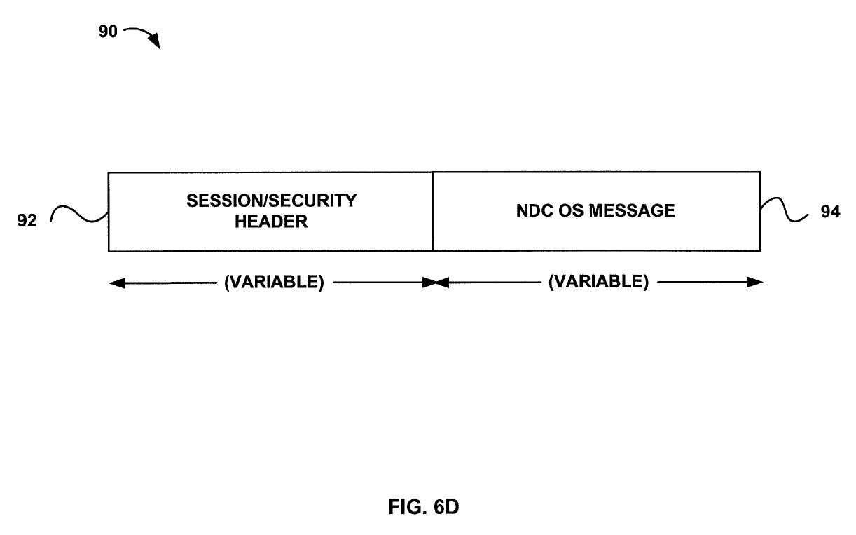

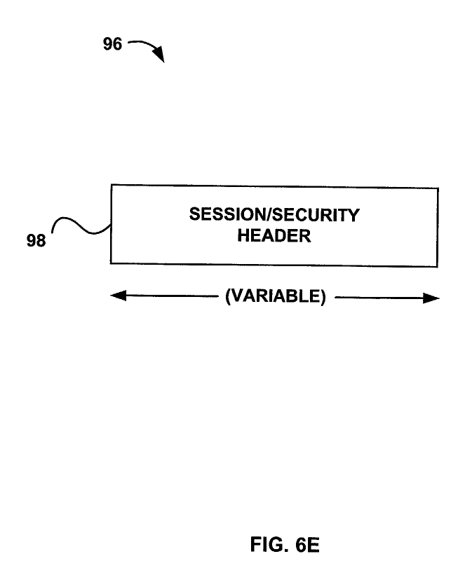

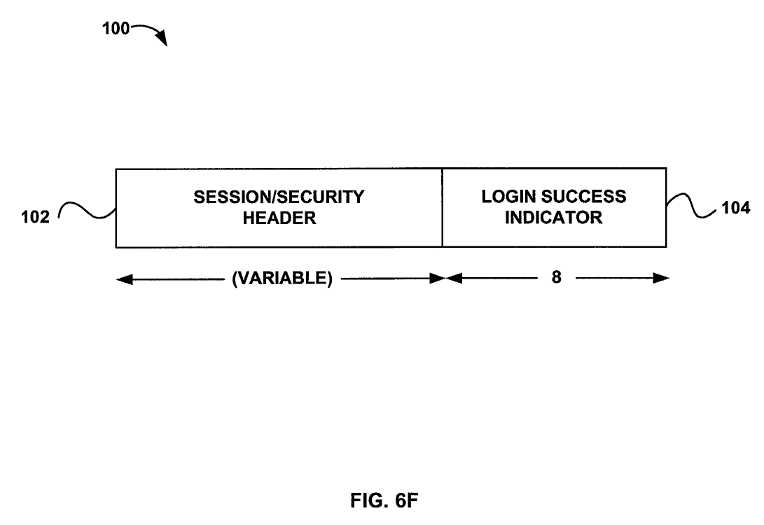

Message version field 62 indicates the version of the messaging protocol used by both the NDC OS software 48 and SDM platform 14. The formats of other message types is illustrated in FIGS. 6A to 6F, and are described more particularly below.

The format of each NDC OS Message body originating with devices 18 and 20 is detailed in the TR-TSY-00740 Document and the TR-NWT-000746 Document. Notably, each NDC OS Message body originating with switch 10 comprises a thirty-two byte generic header, an optional and variable length section header, and NDC OS data. As previously noted the format of each generic header is illustrated in FIG. 4.

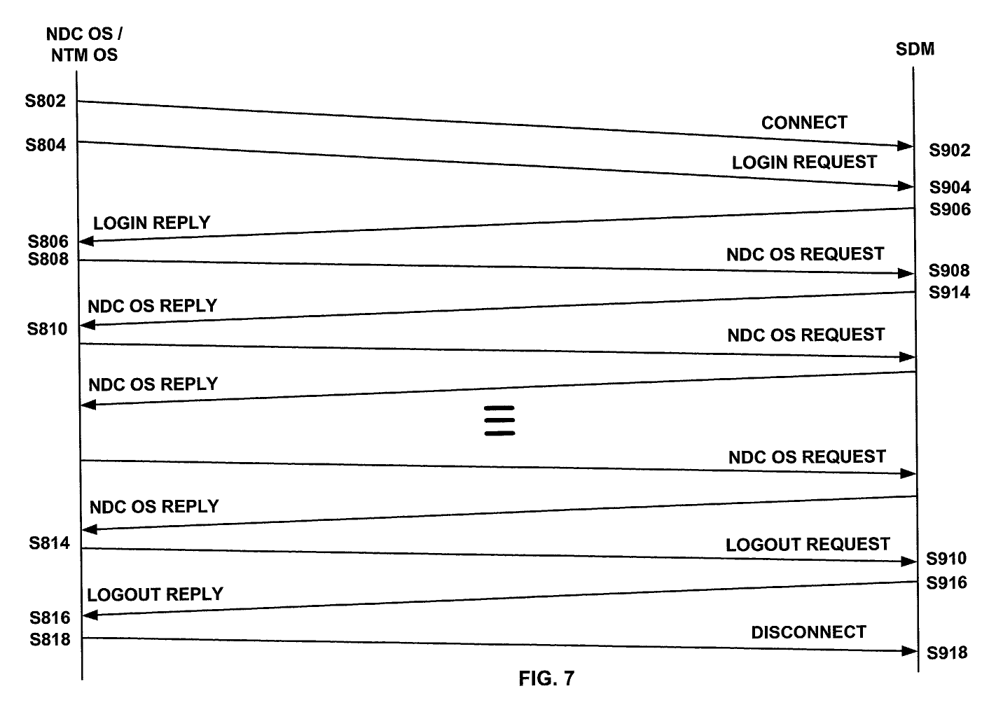

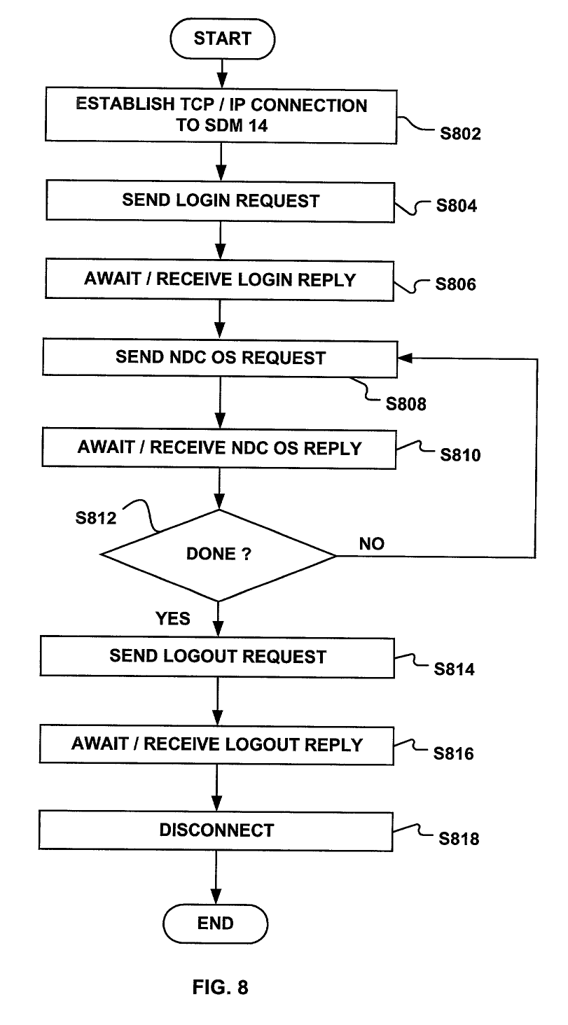

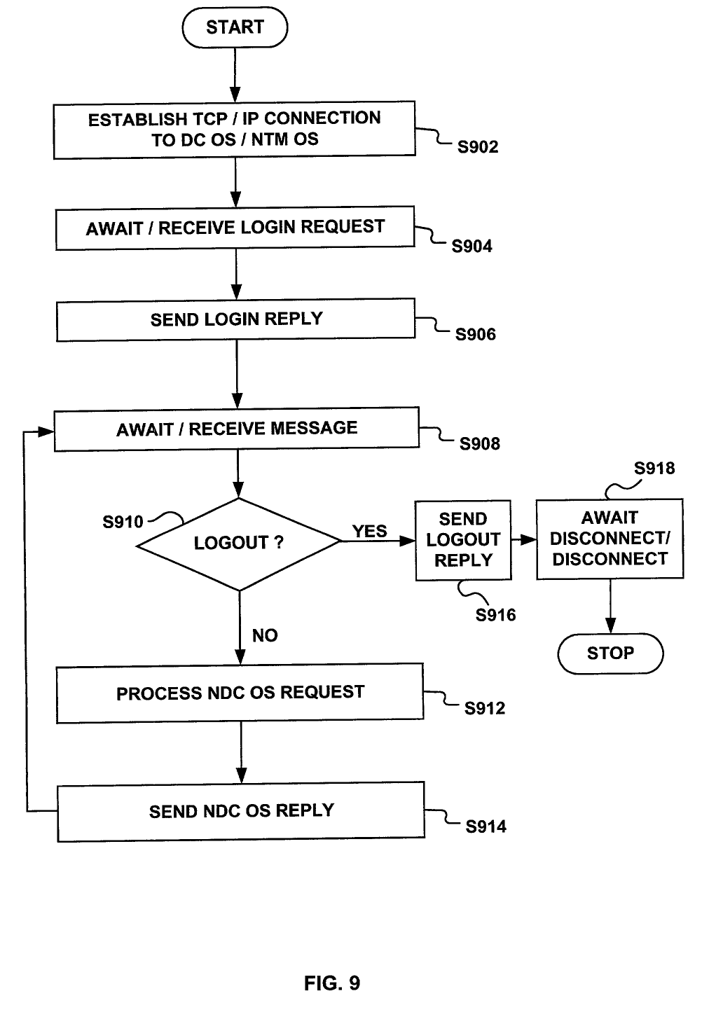

The following illustrates the steps performed by SDM platform 14 and an exemplary computing device 18, in order to exchange operations and administration data between SDM platform 14 (and hence Switch 10) and device 18. Data flow in a message exchange session is illustrated in FIG. 7. Steps performed by SDM platform 14 are detailed in FIG. 8, while steps performed at computing device 18 are detailed in FIG. 9.

In use, an operator at device 18 (FIG. 1) wishes to obtain data collection services from switch 10. Accordingly, the operator initiates a request by typing suitable commands at an input/output peripheral of device 18. Device 18, in turn, in steps S802 and S902, establishes a session with SDM platform 14 over network 16 by contacting a known port, at a known IP address of SDM platform 14.

Specifically, modified software at SDM platform 14, exemplary of an embodiment of the present invention, “listens” at multiple pre-defined IP ports for establishment of a TCP/IP connection. In the preferred embodiment, software at SDM platform 14 monitors logical IP ports 9550, 9551, 9552; and 9553, 9554, 9555. Ports 9550, 9553 correspond to logical channel 1; ports 9551 and 9554 correspond to logical channel 2; and ports 9552 and 9555 correspond to logical channel 3. Each port may be used to establish a single TCP/IP connection corresponding to logical channels detailed above.

Steps illustrated in FIG. 7, 8 and 9 correspond to communications over a single TCP/IP connection. Substantially similar steps are preferably performed concurrently by SDM platform 14, and computing device 18 under control of modified NDC OS software 48. That is, SDM platform 14 and device 18 establish multiple TCP/IP connections between device 16 concurrently. Each TCP/IP connection is used to transport NDC OS message bodies equivalent to NDC OS Messages previously transported over a BX.25 virtual channel as detailed above. Conveniently, channel 1 messages are exchanged using one TCP/IP connection (at port 9550 or 9553 of SDM platform 14); channel 2 messages using another (port 9551 or 9554 of SDM platform 14); and channel 3 messages using a third connection (port 9552 or 9555 of SDM platform 14). As will be appreciated, this allows NDC OS Messages to be exchanged without modification to the application layer messages. As well, higher priority messages will arrive at defined TCP/IP ports for fast handling.

Upon establishing a TCP/IP connection with any of the listened-to ports, SDM platform 14 awaits and receives a login request message in step S904, originating with NDC OS software 48 in step S804 using the established TCP/IP connection.

FIG. 6A illustrates the format of a login request message 70. As illustrated, the login request message 70 has the same general format as message portion 50, and comprises a session/security header 72, followed immediately by a sixteen bit highest version support field 74. Security/session header 72, has the format of security/session header 52 (FIG. 4), and thus comprises a security token 58, formed by the GSS-API library. Security token 58 of session/security header 72, is used to establish a context between modified NDC OS software 48 and SDM platform 14. This token may be obtained from a trusted third party. The context may then be used to ensure unauthorized connection between a client and SDM platform 14 is not possible. A Highest Supported Version parameter in field 74 specifies the highest messaging protocol supported by NDC OS software 48.

Conveniently, devices 18 and 20, as well as SDM platform 14 may implement the open system foundation (“OSF”) distributed computing environment (“DCE”), including its implementation of the GSS-API, as detailed in “OSF DCE Application Development Reference”, Volume 2, 1995, Prentice Hall, the contents of which are hereby incorporated by reference. As will be understood by a person skilled in the art, should devices 18 and 20 use the DCE, then these devices should be within the same “cell” as that term is understood by those skilled in the art.

In step S906, and in response, SDM platform 14 transmits a reply using the established TCP/IP connection. The format of a login reply message 76 is illustrated in FIG. 6B. Again, the login reply message 76 comprises a session/security header 78, followed by a login success indicator field 80 and highest supported version indicator field 82. Session/security header 78 has the generic session/security header format of session/security header 52, illustrated in FIG. 5 and contains a security token formed in response to the security token in header 72 (FIG. 6A). Again, the response security token may be formed using a trusted third party. The login success indicator in field 80 is eight bits long and may have any of the following values, indicating the following conditions:

TABLE III
Login Success Indicators

| Condition | Value |
|---|---|
| login successful (SUCCESS) | 0 |
| security token failed | 1 |
| authentication by GSS API | |
| (AUTHENTICATION FAILURE) | |
| actual message length | 2 |
| inconsistent with specified | |
| length (FORMAT ERROR) | |

Further, the login reply comprises a Highest Supported Version parameter in field 82 that is identical in format and significance to the parameter in field 74 of the login request message 70. As such, the NDC OS Highest Supported Version parameter is combined with the SDM Highest Supported Version parameter, at both SDM platform 14 and device 18 hosting modified NDC OS software 48, to negotiate the application layer protocol version used during the session. The protocol version used, corresponds to the lowest of the Highest Supported Version supported by NDC OS software 48 and at SDM platform 14.

At this point, a session has been established between modified NDC OS software 48 and SDM platform 14. Modified NDC OS software 48 and SDM platform 14 may now exchange NDC OS request and reply messages in steps S808 to S812, and steps S908 to S914. Each request and reply message has the format of messages 84 and 90, illustrated in FIGS. 6C and 6D. Specifically, each request and reply message comprises a session/security header 86, 92 and an NDC OS message body 88, 94, as illustrated in FIGS. 6C and 6D. The session/security header 86 and 92 of the Request and Reply have the format of session/security header 52, illustrated in FIG. 5. Message body 88 and 94 contain NDC OS request and reply messages consistent with the application layer messages detailed in the TR-NWT-000746 and TR-TSY-000740 documents. Each message is authenticated per message using the GSS-API. Tokens are formed using information exchanged during the exchange of login request and reply in establishing a context.

At the conclusion of a session, modified NDC OS software 48 at device 18 transmits a logout request to SDM platform 14 in step S814. A logout request message has the form of message 96, illustrated in FIG. 6E. As such, the message comprises only a session/security header 98 without a message body. Upon receipt of the logout request message, SDM platform 14 forms and transmits a logout reply message in step S914, having the format illustrated in FIG. 6F. As illustrated, the logout reply message 100 comprises a session/security header 102 and an eight bit logout success indicator 104. Success is represented by 00 in success indicator field 104. Upon receipt of a successful Logout Reply message in step S816, modified NDC OS software 48 in step S818 closes the TCP/IP connections established in steps S802 and S902.

As should now be appreciated, the application layer messages used by NDC OS software 48 have not been modified from that specified in the TR-TSY-00740 Document and the TR-NWT-00746 Document. It is expected, however, that if and as the message formats defined in these Documents evolve, the described embodiments may be easily modified without departing from the present invention. Thus, relatively minor software modifications to conventional NTM OS software are required to form modified NTM OS software 48. Similarly, minor modifications to a conventional SDM platform and switch 10 are required to implement the present invention.

As well, an operator at device 20 may wish to exchange NTM OS compliant message with switch 10. This may be accomplished by an operator at device 20 establishing a network management session with SDM platform 14 over network 16, in a manner nearly identical to establishment of a session between device 18 and switch 10, described above. In fact, modified NTM OS software at device 20 could concurrently establish TCP/IP connections with SDM platform 14 using logical ports 9553, 9554 and 9555, while modified NDC OS software 48 of device 18 establishes TCP/IP connections using logical ports 9550, 9551 and 9552.

Alternatively, a circuit could be established between device 22 and device 18. Device 22 could exchange NTM OS messages, as documented in the TR-NWT-000746 document using a physical link connecting device 22 to device 18 (using, for example interface 36) (FIGS. 1 and 2), and the BX.25 protocol. Modified NDC OS software 48 could establish a session with SDM platform 14 over network 16 and pass NTM OS messages between SDM platform 14 (by way of network 16) and device 22. Of course, as will appreciate, connection of a computing device such as device 22 to device 18 is entirely optional. Device 18, accordingly does not need include interface 36.

Similarly, while in the preferred embodiment, switch 10 includes a separate computing device acting as SDM platform 14, a person skilled in the art will appreciate that switch 10 may communicate with network 16 in any number of other ways using the described invention, including by way of a gateway; by way of direct interconnection to network 16, or in numerous other ways understood by those skilled in the art.

While the above described methods rely on use of the GSS-API in order to authenticate exchanged messages, a person skilled in the art will appreciate that other authentication techniques could be used. Moreover, NDC OS software, as modified, could support insecure message exchange without use of the GSS-API.

Moreover, while the organization of software blocks, have In been illustrated as clearly delineated, a person skilled in the art will appreciate that the delineation between blocks is somewhat arbitrary. Numerous other arrangements of software blocks are possible.

It will be further understood that the invention is not limited to the embodiments described herein which are merely illustrative of a preferred embodiments of carrying out the invention, and which are susceptible to modification of form, arrangement of parts, steps, details and order of operation. The invention, rather, is intended to encompass all modifications within its spirit and scope, as defined by the claims.

What is claimed is:

1. A method of requesting operations and management data from a telephony switch at a computing device, said telephony switch and said computing in communication with a packet switched data network, said method comprising:
a. establishing a connection between said computing device and said telephony switch over said packet switched data network;
b. forming at least one packet comprising:
i. a network address identifying said telephony switch on said packet switched network;
ii. a network address identifying said computing device;
iii. a first message type identifier, identifying a message contained at least partially within said packet, as a data request message;
iv. a second message type identifier, identifying a type of operations and management data requested from said telephony switch;
c. forwarding said packet from said computing device to said telephony switch using said data network.

2. The method of claim 1, wherein said packet further comprises, a security token allowing said switch to authenticate said computing device as a computing device authorized to request said operations and management data.

3. The method of claim 1, further comprising:
prior to b. exchanging login request and login reply messages between said computing device and said telephony switch, thereby establishing a message exchange session.

4. The method of claim 1, wherein said message comprises an internet protocol compliant network.

5. The method of claim 4, wherein said connection comprises a TCP/IP connection and said at least one packet is TCP/IP compliant.

6. The method of claim 1, wherein said connection with said switch is established by way of an intermediate computing platform.

7. A method of providing operations and management data from a telephony switch to a computing device, said telephony switch and said computing in communication with a packet switched data network, said method comprising:
a. in response to a request for operations and management data, forming at least one packet comprising:
i. a network address identifying said telephony switch on said packet switched network;
ii. a network address identifying said computing device;
iii. a first message type identifier, identifying said packet as at least partially containing a message formed in response to a request;
iv. a second message type identifier, identifying a type of operations and management data provided by in said packet;
b. forwarding said packet from said telephony switch to said computing device using said data network.

8. The method of claim 7, wherein said packet further comprises an alphanumeric identifier of said telephony switch.

9. The method of claim 7, wherein said packet further comprises a security token allowing said computing device to authenticate said switch as a proper switch responding to a request.

10. The method of claim 7, further comprising,
prior to a. exchanging login request and login reply messages between said computing device and said telephony switch, thereby establishing a message exchange session.

11. A method of exchanging operations and management data between a telephony switch and a computing device, said telephony switch and said computing in communication with a packet switched data network, said method comprising:
a. establishing at least first and second network connections between said computing device and said telephony switch over said packet switched data network;
b. exchanging data having a first priority over said first network connection;
c. concurrently exchanging data having a second priority over said second network connection.

12. The method of claim 11, wherein said packet switched network adheres to the internet protocol.

13. The method of claim 13, wherein said connections are TCP/IP connections, at first and second defined logical ports at said telephony switch.

14. The method of claim 11, further comprising encapsulating operations and management messages having a pre-defined format in data packets to exchange said messages in b. and c.

15. A computer readable medium, containing computer readable instructions, that when loaded into a computing device comprising a network interface for interconnection with a packet switched data network, adapts said computing device to:
a. establish a connection with a telephony switch over said packet switched data network
b. form at least one packet comprising:
i. a network address identifying said telephony switch on said packet switched network;
ii. a network address identifying said computing device;
iii. a first message type identifier, identifying said packet as at least partially containing a data request message;
iv. a second message type identifier, identifying a type of operations and management data requested from said telephony switch;
c. forward said at least one packet from said computing device to said telephony switch using said data network.

16. A computing device, comprising
a processor;
a data network interface, in communication with said processor;
processor readable memory, comprising processor readable instructions, adapting said device to:
a. establish a connection with a telephony switch over a packet switched data network in communication with said network interface;
b. form at least one packet comprising:
i. a network address identifying said telephony switch on said packet switched network;
ii. a network address identifying said computing device;
iii. a first message type identifier, identifying said packet as at least partially containing a data request message;
iv. a second message type identifier, identifying a type of operations and management data requested from said telephony switch;
c. forward said at least one packet from said computing device to said telephony switch using said data network interface.

16. A digital telephony switch, comprising
a processor;
a data network interface, in communication with said processor;
processor readable memory, comprising processor readable instructions, adapting said switch to:
a. in response to a request for operations and management data, form at least one data packet comprising:
i. a network address identifying said telephony switch on a packet switched network in communication with said network interface;
ii. a network address identifying said computing device;
iii. a first message type identifier, identifying said packet as at least partially containing a message formed in response to a request;
iv. a second message type identifier, identifying a type of operations and management data provided by in said packet;
b. forward said packet from said telephony switch to said computing device using said data network interface.
